(19) United States
(12) Patent Application Publication
(10) Pub. No.: US 2002/0078694 A1
(43) Pub. Date: Jun. 27, 2002

(54) Method to enhance fuel atomization for a liquid fuel combustor

(76) Inventors: Waseem A. Nazeer, Rancho Palos Verdes, CA (US); Samir S. Ahmad, Rancho Palos Verdes, CA (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/745,791

(22) Filed: Dec. 22, 2000

(51) Int. Cl. F02C 7/22

(52) U.S. Cl. 60/776; 60/734

(57) ABSTRACT

A method is provided for atomizing fuel in a turbine engine having a compressor, turbine, recuperator, and combustor. The steps include flowing a compressed air to the combustor and passing a fuel to the combustor. A compressed air pressure from the compressor is sensed, as well as sensing a first pressure of an assist air. The first pressure is compared to the compressed air pressure. Then, the first pressure is adjusted to a desired pressure that is a function of at least one of the operating parameters such as turbine speed and the compressed air pressure. The assist air at the desired pressure is next moved to the combustor.

### BACKGROUND OF THE INVENTION

The present invention generally relates to fuel combustion for turbine engines and, more particularly, to an apparatus and method of enhancing fuel atomization in a combustor over a broad operating range of engine loads and ambient conditions.

Gas turbine engines commonly employ a compressor for compressing air and a combustor for combusting compressed air and fuel. Hot exhaust gases from the combustor are fed to a turbine to drive a driveshaft. Turbine exhaust is fed to a recuperator that places the exhaust in heat exchange relationship with compressed air from the compressor. The heat exchange heats the compressed air and thereby enables heat recovery by the heated compressed air flowing to the combustor.

However, gas turbine engines are typically needed to operate over a wide range of operating conditions, including start-up or light-off, low speed, and high speed. Each of these operating conditions requires different fuel flows, with light-off requiring low fuel flow and high speed requiring high fuel flow. During light-off conditions, the fuel must also be sufficiently atomized to support ignition. Likewise, during high-speed conditions, the fuel must continue to be atomized to support continued combustion. Improper atomization of the fuel inside the combustor also leads to the formation of undesirable combustion products such as NOx, CO, and UHC's.

Various systems have been used in the past to overcome the issue to liquid fuel atomization to support combustion with each having certain advantages and disadvantages. The most common approach has been to use multiple fuel nozzles to cover the entire range of fuel flows, such as a low flow nozzle for startup and a high flow nozzle for maximum speed operation. In such a setup, a small orifice nozzle capable of providing adequate atomization at low fuel flows is used during startup and when some steady state condition is achieved, fuel is diverted to a high flow nozzle capable of delivering maximum possible fuel required by the engine. The disadvantage of such a system is that it adds cost and complexity to the fuel delivery system.

To provide fuel atomization, past designs have utilized air assist atomizers. An idea has been disclosed to modulate the amount of assisted air in accordance with the amount of fuel flow such that increased air is provided with increased fuel flow, or vice versa. However, the means by which this can be accomplished has been left unanswered.

A perceived disadvantage to air assist atomizers is that a separate pump may be needed. Use of the compressor to provide the atomizing air during light-off conditions often produces insufficient airflow and, thus, insufficient airflow to the atomizer. Another perceived disadvantage to air assist atomizers is that a separate source of high-pressure air is needed and the source, such as an air flask, may only provide a limited amount of high-pressure air.

However, there are certain advantages of using air assist nozzles. They can provide adequate fuel atomization for a wide range of fuel flows. Also, atomizing air provides cooling to the outer jacket of the nozzle to keep fuel temperatures below levels that would otherwise cause a vapor lock inside the fuel tube resulting in disruption of fuel to the combustor. Another advantage of air assist nozzles is that fuel atomization is achieved by the combination of air and fuel delivery pressures; as such, it reduces the fuel delivery pressure requirement from a fuel pump.

As can be seen, there is a need for an apparatus and method of atomizing fuel to a combustor of a gas turbine engine, such as a microturbine. Another need is for an apparatus and method of atomizing fuel to a combustor over a broad range of turbine operating conditions. Yet a further need is for an apparatus and method of modulating fuel atomization based on various turbine-operating characteristics, such as turbine speed and/or compressor discharge pressure. Also needed is an apparatus and method of modulating fuel atomization from light-off operation to high-speed turbine operation.

Accordingly, in one aspect of the present invention, a turbine engine system comprises a compressor; a turbine engaged to the compressor; a combustor in communication with the turbine; a fuel source in communication with said combustor; an air assist pump in communication with the combustor; a first pressure sensor intermediate the air assist pump and combustor; and a second pressure sensor intermediate the compressor and combustor.

In another aspect of the present invention and for a turbine engine system having a compressor, turbine, combustor, and recuperator, a fuel atomization subsystem comprises an air assist pump in communication with the combustor; a first pressure sensor intermediate the air assist pump and combustor; a second pressure sensor intermediate the compressor and combustor; and a control logic subsystem that generates commands as a function of one of compressed air pressure from the compressor and engine speed from the turbine engine system.

A further aspect of the present invention includes a method of combusting fuel in a turbine engine, comprising flowing a compressed air to a combustor; flowing a fuel to the combustor; sensing a first pressure of an assist air; comparing the first pressure to a desired pressure; adjusting the first pressure to an adjusted pressure; and moving the assist air at the adjusted pressure to the combustor.

These and other features, aspects and advantages of the present invention will become better understood with reference to the following drawings, description and claims.

### BRIEF DESCRIPTION OF THE DRAWINGS

FIG. 1 is a schematic diagram of a turbine engine system having fuel atomization according to the present invention;

FIG. 2 is a simplified, schematic diagram of a control logic subsystem utilizing compressed air pressure and a variable speed air assist pump in the turbine engine system of FIG. 1;

FIG. 3 is a simplified, schematic diagram of a control logic subsystem utilizing engine speed and a variable speed air assist pump in the turbine engine system of FIG. 1;

FIG. 4 is a simplified, schematic diagram of a control logic subsystem utilizing compressed air pressure and a modulating valve in the turbine engine system of FIG. 1;

FIG. 5 is a simplified, schematic diagram of a control logic subsystem utilizing engine speed and a modulating valve in the turbine engine system of FIG. 1;

FIG. 6 is a simplified flow chart of the steps carried out by the control logic subsystems of FIGS. 2-5;

FIG. 7A is a graph of engine speed and air-assist pressure during a fixed speed light-off condition according to an embodiment of the present invention;

FIG. 7B is a graph of engine speed and air-assist pressure during a variable speed light-off condition according to an embodiment of the present invention.

### DETAILED DESCRIPTION OF THE INVENTION

In general, and in contrast to the prior art, the present invention enables modulation of fuel atomization for a turbine engine over a wide range of engine operating conditions from light-off to high speed. The present invention also enables such modulation over a wide range of ambient conditions from sea level to about 10,000 ft. altitude and −20 F. to 120 F. The modulation may occur in accordance with the present invention as a function of either compressed air pressure from a compressor or turbine speed of a turbine in the system. In either case, a variable speed air assist pump or a constant speed air assist pump together with a modulating valve upstream of a combustor is provided for modulation. The speed of the air assist pump may be increased or decreased depending upon the system operating conditions. For example, when higher engine speed demands higher fuel flow rate, the present invention can provide increased fuel atomization and vice versa. In another aspect of the invention, if the air assist pump is not variable in speed, the modulating valve may be opened or closed depending upon the desired airflow rate and, thus, amount of atomization.

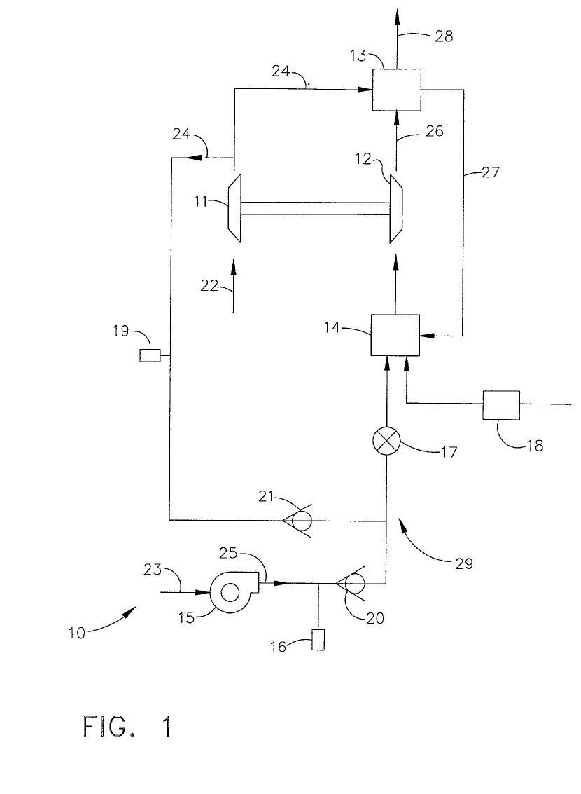

More specifically, and in reference to FIG. 1, the present invention provides a turbine engine system 10 that may be a microturbine engine system. The engine system 10 may include an air source 22 that feeds air to a compressor 11, which is mechanically engaged to a turbine 12. A recuperator 13 may be provided downstream of the turbine 12 such that an exhaust air 26 from the turbine 12 may be used in the recuperator 13 to heat a compressed air 24 from the compressor 11. By such heat exchange, a heated compressed air 27 may flow from the recuperator 13 and to a combustor 14. Concurrently, a cooled turbine exhaust 28 is discharged from the recuperator 13.

The combustor 14 may receive fuel from a fuel source 18. It may also receive from a fuel atomization subsystem 29 the compressed air 24 or an assist air 25 as further explained below. The fuel atomization subsystem 29 may include an air assist pump 15 that may be of a fixed speed or variable speed type. A first or air assist pressure sensor 16 may be downstream of the air assist pump 15 in order to sense the pressure of the assist air 25 (P_air) being produced by the pump 15. A first check valve 20 may be downstream of the first pressure sensor 16.

The fuel atomization subsystem 29 may further include a second or pressure compressor discharge (PCD) sensor 19 downstream of the compressor 11 in order to sense the pressure of the compressor discharge or compressed air 24. A second check valve 21 may be downstream of the second pressure sensor 19 such that the second check valve 21 is closed and the first check valve 20 is opened whenever the pressure of the PCD air 24 (P_pcd) is less than the maximum pressure of the assist air 25 (P_air_max) that can be produced by the pump 15, as further described below.

A modulating valve 17 may be optionally provided downstream of the first and second check valves 20, 21 and as part of the fuel atomization subsystem 29, such as when the air assist pump 15 is of a fixed speed type. In such instance, the fixed speed air assist pump 15 can operate at only one designed speed that, in turn, produces only one designed pressure of assist air 25. Thus, only the one pressure of assist air 25 may be produced irrespective of the system 10 demands for lower or higher fuel flow rate for differing operating and/or ambient conditions. Therefore, the modulating valve 17 may be closed or opened to modulate the assist air 25 at a flow rate or pressure that is consistent with the demand for lower or higher fuel flow rate.

In view of the foregoing, it can be seen that the modulating valve 17 may not be needed in the system 10 when the air assist pump 15 is of a variable speed type. This is because the speed of the pump 15 may be varied to modulate (i.e., lower or raise) the flow rate or pressure of the assist air 25 to meet the changing demands of the system 10. Nevertheless, the present invention contemplates that the modulating valve 17 may be used in conjunction with a variable speed air assist pump 15.

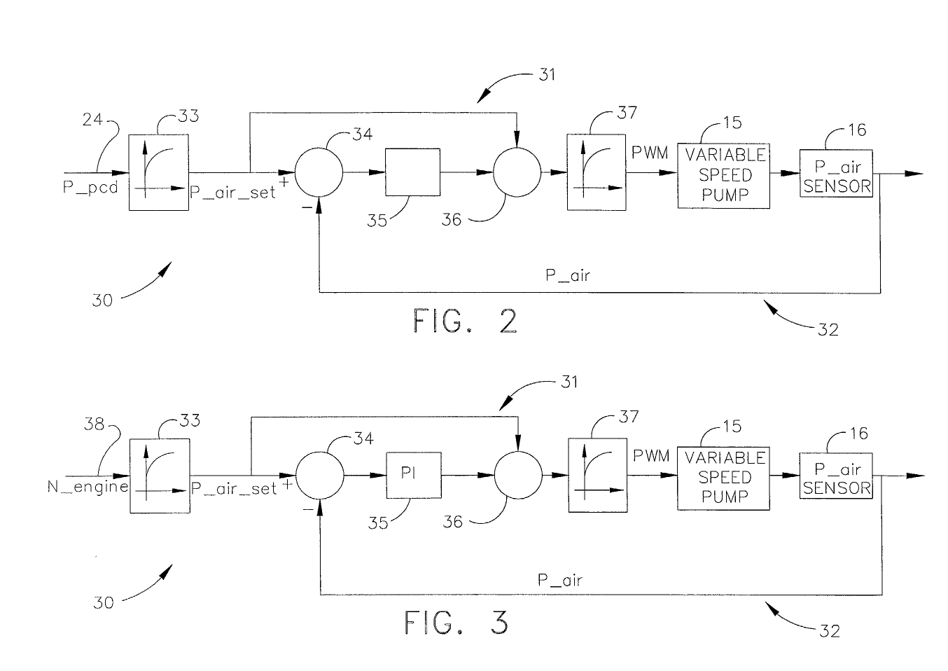

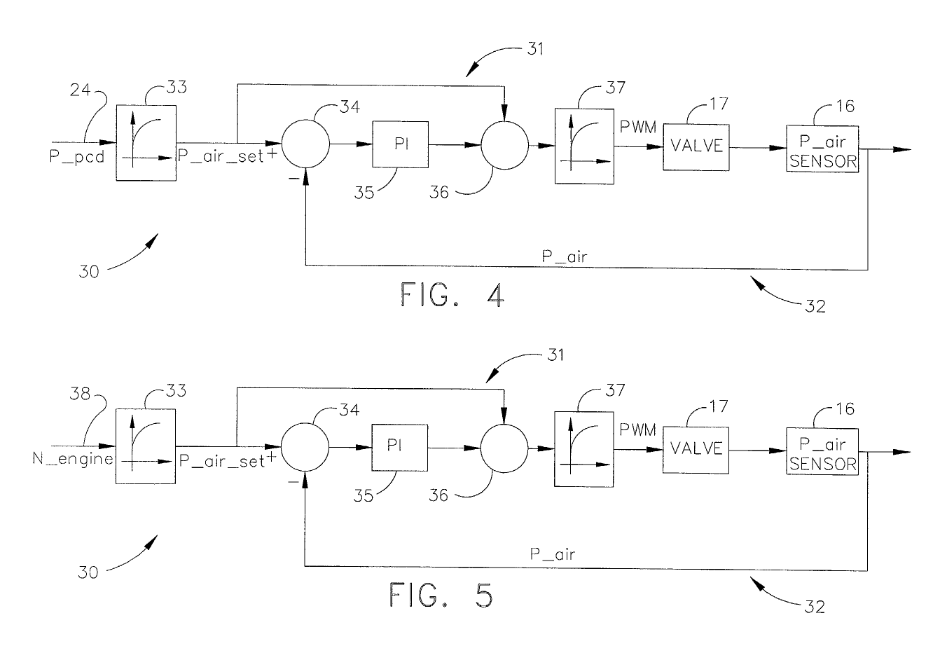

As mentioned above, the engine system 10 and, specifically, the fuel atomization subsystem 29, may operate as a function of either the pressure of the PCD air 24 or the speed of the engine system 10 and, specifically, the turbine 12 speed. Further, the present invention contemplates that the system 10 may operate as a function of both PCD pressure and engine speed. The operation of the fuel atomization subsystem 29 may be controlled by a control logic subsystem 30 that may be of a feed forward type. As such, the logic subsystem 30 may comprise an open or feed forward loop 31 and a closed or feedback loop 32. FIGS. 2 and 3 schematically depict two embodiments of the control logic subsystem 30 that employ PCD pressure (P_pcd) as the functional parameter. FIGS. 4 and 5 schematically depict two additional embodiments of the control logic subsystem 30 but which employ engine (i.e., turbine 12) speed (N_engine 38) as the functional parameter.

In the control logic subsystem 30 schematically shown in a simplified fashion in FIG. 2, the PCD sensor 19 (not shown) may generate a P_pcd signal indicative of the pressure of the PCD air 24. The P_pcd signal may then be transmitted to a first data or look-up table 33 that contains various desired pressures that have been calculated based upon parameters such as ambient temperature, ambient pressure, turbine speed, and combustor inlet temperature. The specific parameters used may vary, as well as the method of calculation. As a result of above mentioned operating parameters, a desired pressure P_air_set is selected from the first data table 33. A P_air_set signal indicative of the desired pressure is generated and may preferably be a part of the open loop 31 that forms a part of the control logic subsystem 30, as mentioned above. In general, the open loop 31 serves to improve the ability of the control logic subsystem 30 to respond to commands, thereby increasing the speed at which the control logic subsystem 30 operates. Consequently, the open loop 31 may be deemed optional and, therefore, eliminated from the subsystem 31, if desired.

Assuming that the open loop 31 is utilized, the P_air_set signal bypasses a summing junction 34 and a proportional integral controller 35 (both of which are described below) and is sent to a summing point 36 that forms a part of the closed loop 32 mentioned above. From the summing point 36, the P_air_set, together with a correcting signal described below, may be transmitted to a second data or look-up table 37 in the closed loop 32. Table 37 may generate a pulse width modulation (PWM) signal. The PWM signal may then be sent to the variable speed air assist pump 15 in the closed loop 32 to alter the speed of the pump 15. Upon the downstream P_air sensor 16 sensing a first pressure of the assist air 25 from the pump 15, the P_air sensor 16 may then send a P_air signal indicative of such first pressure.

The P_air signal may next be received by the summing junction 34 of the closed loop 32 whereby the P_air signal is compared to the P_air_set signal. Upon such comparison, an error signal may be sent to a proportional and integral controller 35 of the closed loop 32 and that serves to minimize error. From the controller 35, a correcting signal is transmitted to the summing point 36 whereby the closed loop 32 is completed. As a result, the first pressure of the assist air 25 is adjusted to equal the desired pressure. The assist air 25 at the desired pressure may then be sent to the combustor 14.

FIG. 3 schematically depicts in a simplified fashion another embodiment of the control logic subsystem 30 which is the same as that in FIG. 2, except that the desired pressure P_air_set is a function of turbine 12 speed N_engine 38. Accordingly, a speed sensor (not shown) may send an N_engine 38 signal to the first data table 33 to generate the P_air_set signal.

In FIG. 4, as in the embodiment of FIG. 2, the control logic subsystem 30 schematically shown in a simplified fashion again uses P_pcd as the functional parameter to modulate P_air. However, in contrast to the embodiment of FIG. 2, the modulating valve 17 replaces the variable speed air assist pump 15 in the closed loop 32. Consequently, the PWM signal in the closed loop 32 modulates the valve 17 to either open or close it in order to adjust the P_air.

FIG. 5 schematically depicts in a simplified fashion another embodiment of the control logic subsystem 30 which is the same as that in FIG. 4, except that the desired pressure P_air_set is a function of turbine 12 speed N_engine 38.

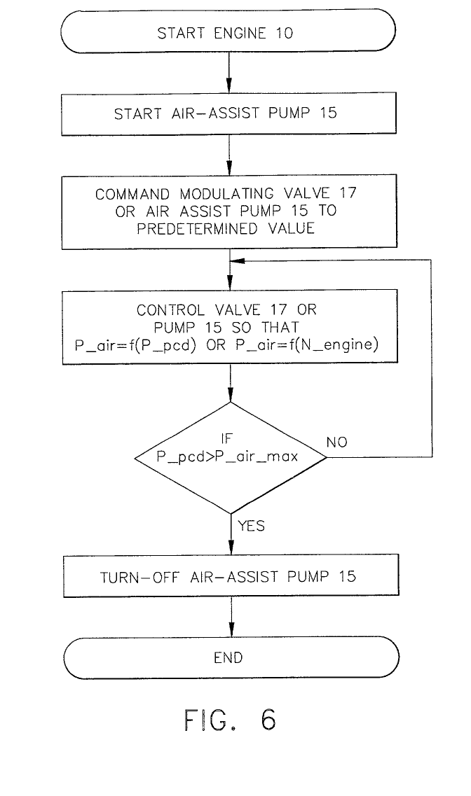

FIG. 6 is a flow chart of the logic steps accomplished by the control logic subsystem 30 for either modulation of the valve 17 (when the pump 15 may be of a fixed speed) or modulation of the variable speed air assist pump 15 (when the valve 17 may not be used). The engine system 10 is started, as well as the pump 15. The valve 17 or the variable speed air assist pump 15 is commanded by the PWM signal described above to a predetermined value, such as for light-off. The predetermined value is derived from the P_air_set found in the first data table 33 described above and shown in FIGS. 2-5. A control command in the form of the PWM signal is sent to either the valve 17 or the variable speed air assist pump 15 such that P_air is either a function of P_pcd or N-engine. The variable speed air assist pump 15 remains on until P_pcd exceeds P_air_max (not shown in FIGS. 2-5). At such time, the variable speed air assist pump 15 is turned off, the assist air 25 is precluded from moving to the combustor 14, and the PCD air 24 flows through the check valve 21, past the valve 17, and into the nozzle (not shown) of the combustor 14.

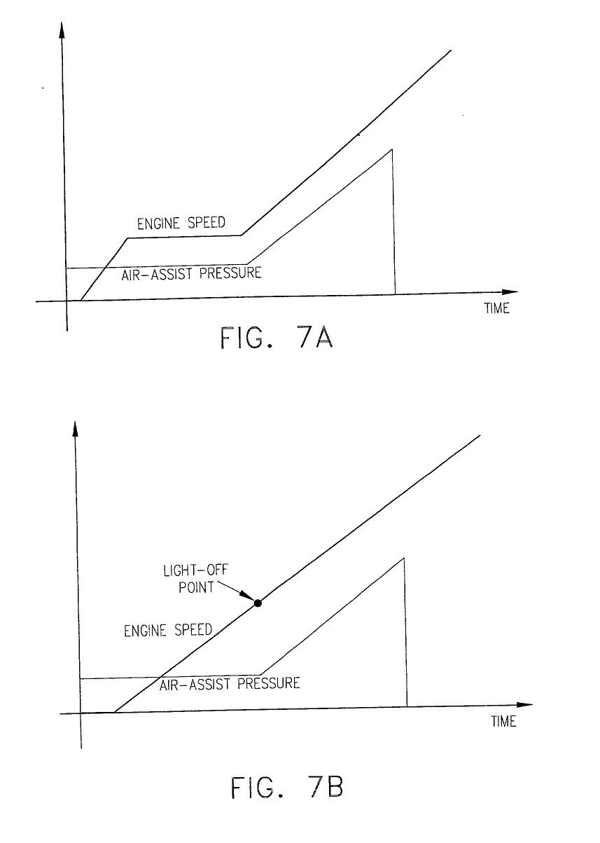

The operation of the present invention is exemplified in FIGS. 7A and 7B. In FIG. 7A, a fixed speed light off is shown such that the air assist pressure P_air remains constant until light off is achieved and then increases as engine speed increases. Upon the pressure of the PCD air 24 (P_pcd) exceeding P_air_max, the pump 15 is turned off such that P_air falls to zero. In FIG. 7B, a variable speed light off is shown such that P_air remains constant until light off is achieved. Thereafter, P_air increases until P_pcd exceeds P_air_max when the pump 15 is turned off and P_air falls to zero.

In the foregoing specification, the invention has been described with reference to specific embodiments. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. In addition, benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential features or elements of any or all the claims. As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

We claim:

1. A turbine engine system, comprising:
a compressor;
a turbine engaged to the compressor;
a combustor in communication with said turbine;
a fuel source in communication with said combustor;
an air assist pump in communication with said combustor;
a first pressure sensor intermediate said air assist pump and combustor; and
a second pressure sensor intermediate said compressor and combustor.

2. The system of claim 1, further comprising a recuperator intermediate said turbine and combustor.

3. The system of claim 1, further comprising a first check valve downstream of said first pressure sensor.

4. The system of claim 3, further comprising a second check valve downstream of said second pressure sensor.

5. The system of claim 1, wherein said air assist pump is one of a variable speed type and a fixed speed type.

6. The system of claim 1, further comprising a modulating valve downstream of said first and second pressure sensors.

7. The system of claim 1, further comprising a control logic subsystem having an open loop and a closed loop.

8. The system of claim 7, wherein said open loop comprises a feed forward loop.

9. The system of claim 7, wherein said closed loop comprises a feedback loop.

10. The system of claim 9, wherein said feedback loop comprises said air assist pump and wherein said air assist pump is of a variable speed type.

11. The system of claim 9, wherein said feedback loop comprises a modulating valve upstream of said combustor.

12. The system of claim 10, wherein said control logic subsystem generates commands as a function of at least one of air pressure from said compressor and speed of said turbine.

13. In a turbine engine system having a compressor, turbine, combustor, and recuperator, a fuel atomization subsystem comprising:
an air assist pump in communication with said combustor;
a first pressure sensor intermediate said air assist pump and combustor;
a second pressure sensor intermediate said compressor and combustor; and
a control logic subsystem that generates commands as a function of one of compressed air pressure from said compressor and engine speed from said turbine engine system.

14. The system of claim 13, wherein said control logic subsystem is of a feed forward type.

15. The fuel atomization subsystem of claim 14, wherein said control logic subsystem includes said first pressure sensor.

16. The fuel atomization subsystem of claim 15, wherein said control logic subsystem further includes one of said air assist pump and a modulating valve upstream of said combustor.

17. The system of claim 16, wherein said air assist pump is of a variable speed type.

18. A method of combusting fuel in a turbine engine, comprising:
flowing compressed air to a combustor;
passing a fuel to said combustor;
sensing a first pressure of an assist air;
comparing said first pressure to a desired pressure;
adjusting said first pressure to said desired pressure;
moving said assist air at said desired pressure to said combustor.

19. The method of claim 18, further comprising precluding said assist air from moving to said combustor when said desired pressure is greater than a compressed air pressure from a compressor upstream of said combustor.

20. The method of claim 19, further comprising selecting one of said compressed air pressure and said desired pressure to flow to said combustor.

21. The method of claim 18, wherein said desired pressure is a function of a compressed air pressure from a compressor upstream of said combustor.

22. The method of claim 18, wherein said desired pressure is a function of an engine speed of said turbine engine.

23. The method of claim 18, wherein adjusting said first pressure comprises modulating a valve intermediate said combustor and an upstream air assist pump.

24. The method of claim 18, wherein adjusting said first pressure comprises varying a speed of an air assist pump upstream of said combustor.

25. A method of atomizing fuel in a turbine engine having a compressor, turbine, recuperator, and combustor, comprising:
flowing a compressed air to said combustor;
passing a fuel to said combustor;
sensing a compressed air pressure from said compressor;
sensing a first pressure of an assist air;
comparing said first pressure to said compressed air pressure;
adjusting said first pressure to a desired pressure that is a function of at least one of engine speed of said turbine and said compressed air pressure;
moving said assist air at said desired pressure to said combustor.

26. The method of claim 25, further comprising precluding said assist air at said desired pressure from moving to said combustor when said compressed air pressure exceeds said first pressure.

27. The method of claim 25, wherein adjusting said first pressure comprises modulating a valve intermediate said combustor and an upstream air assist pump.

28. The method of claim 25, wherein adjusting said first pressure comprises varying a speed of an air assist pump upstream of said combustor.
